(19) United States
(12) Patent Application Publication
(10) Pub. No.: US 2004/0090025 A1
(43) Pub. Date: May 13, 2004

(54) Child seat for a shopping trolley

(75) Inventor: Bernd Frommherz, Wutoschingen/Hortheim (DE)

Correspondence Address: BURNS DOANE SWECKER & MATHIS L L P, POST OFFICE BOX 1404, ALEXANDRIA, VA, 22313-1404, US

(73) Assignee: Wanzl Metallwarenfabrik GmbH

(21) Appl. No.: 10/670,400

(22) Filed: Sep. 26, 2003

Related U.S. Application Data
(63) Continuation of application No. PCT/DE02/04326, filed on Nov. 26, 2002.

(30) Foreign Application Priority Data
Apr. 12, 2001 (DE) DE 101 594 45.3

(51) Int. Cl. B62B 5/00

(52) U.S. Cl. 280/33.993

(57) ABSTRACT

A child seat (1) for a shopping trolley (22) includes a back rest (7) made of plastic and is arranged on the shopping trolley (22) so as to be pivotable about a horizontal axis (9) and to which at least one seat (6) is slidably or pivotably connected. The back rest (7) includes at least two parts (17, 18) fixedly connected to one another and constructed so that at least one portion (19) of the back rest (7) is formed as a hollow body.

### CROSS-REFERENCE TO RELATED APPLICATIONS

The present application is continuation of PCT/DE02/04326, filed on Nov. 26, 2002, and which claims the priority of DE 101 594 45.3, filed in Germany on Dec. 4, 2001. The contents of PCT/DE02/04326 and DE 101 594 45.3 are incorporated herein by reference.

### BACKGROUND OF THE INVENTION

1. Field of the Invention

The present invention relates to a child seat for a shopping trolley.

2. Discussion of Related Art

Child seats are used in shopping trolleys which are at least partly made of plastic. The back rests of the child seats of these trolleys are either wire structures or structures comprising wire and plastic or are made entirely of plastic. For reasons of stability, the latter have to be provided with reinforcing ribs to enable them to withstand the loads occurring in practice. Reinforcing ribs have the disadvantage that they have an unpleasant appearance and that dirt collects on them.

### OBJECTS AND SUMMARY

Objects of the invention include providing a back rest for a child seat for a shopping trolley that will maintain adequate stability, and the back rest can be formed as smoothly as possible, and so that it is at least partly free of visible reinforcing ribs.

A back rest comprises at least two parts fixedly connected to one another and constructed so that at least one portion of the back rest is formed as a hollow body.

An advantage of an embodiment of the invention resides in the fact that the reinforcing ribs are provided on fixedly connected parts so as to be arranged opposite one another in the at least one portion. Consequently, they are housed in the portions formed as hollow bodies and are not visible from the outside, with the result that it is possible for the external and also visible surfaces of the back rest to be completely smoothly formed. In this way, dirt cannot collect and the internal reinforcing ribs nevertheless contribute towards ensuring the necessary stability of the back rest.

A further advantage resides in the fact that the at least one portion in the form of a hollow body can be provided with openings, slots and the like, in which, if necessary, functional parts or elements can be internally arranged to form, together with the slots or openings, e.g. guides, holding devices or the like which are necessary or advantageous for the operation and movement of the child seat.

The invention will be further described with reference to embodiments.

### BRIEF DESCRIPTION OF THE PREFERRED EMBODIMENTS

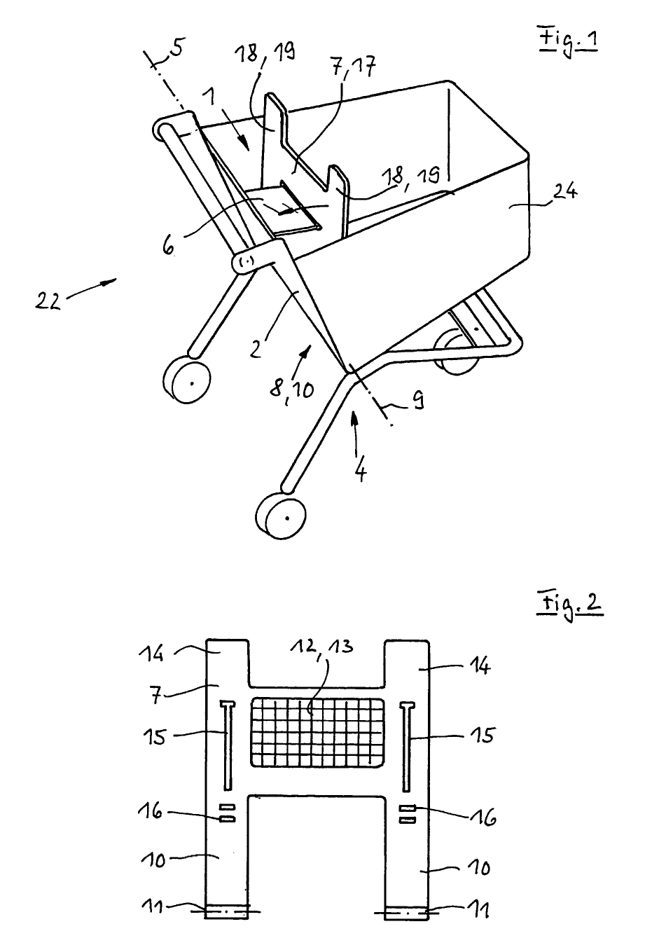

FIG. 1 shows an embodiment of a child seat provided on a shopping trolley;

FIG. 2 shows a front view of a back rest of the child seat;

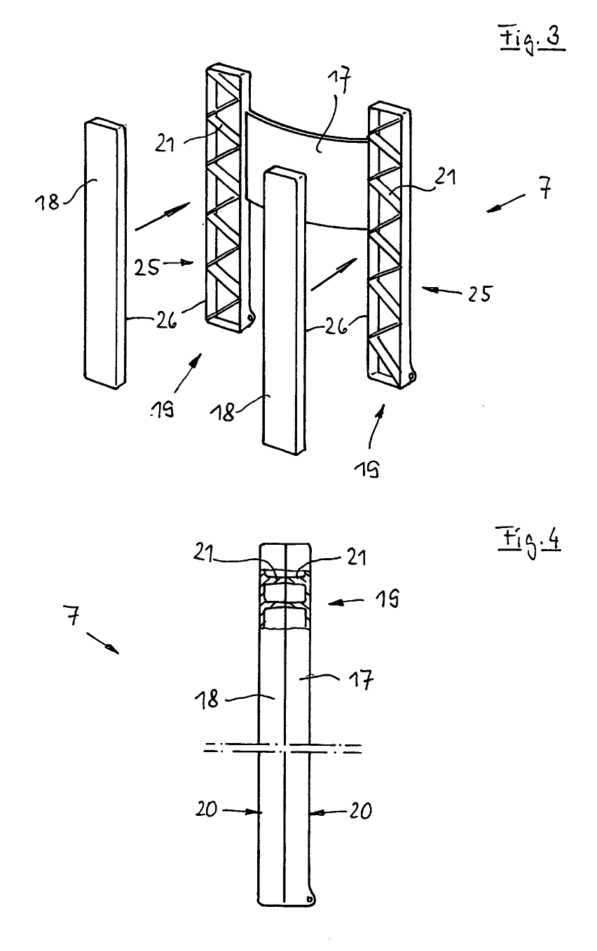

FIG. 3 shows a back rest of an embodiment to be formed from three parts; and

FIG. 4 shows a side view of the back rest.

### DETAILED DESCRIPTION OF THE PREFERRED EMBODIMENTS

The child seat 1 shown in FIG. 1 and arranged on a shopping trolley 22 is shown in the position of use. The child seat 1 comprises a seat 6 and a back rest 7, the seat 6 being slidably or pivotably connected to the back rest 7. The rear of the basket 24 of the shopping trolley 22 is formed by a wall 2 which is pivotable about an upper horizontal axis 5 into the interior of the basket. The back rest 7 is mounted, by means of its lower boundary 8 or by means of downwardly extending supports 10, on the wall 2 so as to be pivotable to a limited extent about a horizontal axis 9 arranged in a lower region 4 of the wall 2. The seat 6 is also supported on the wall 2 either pivotably or slidably. This type of arrangement and construction is known. The back rest 7 is pivotable towards the wall 2 in the direction of the arrow, while the wall 2 together with the seat 6 and the back rest 7 can be pivoted about the horizontal axis 5 into the interior of the basket for the purpose of pushing a plurality of shopping trolleys 22 together.

FIG. 2 shows a front view of the back rest 7 of a child seat 1. The back rest 7, which is reminiscent of a capital “H” and is made of plastic, has two downwardly extending supports 10 provided with bearing lugs 11 for mounting on the horizontal axis 9. The supports 10 are upwardly adjoined by a supporting region 12, against which a child sitting in the child seat 1 can rest. The back rest 7 upwardly ends in two projections 14 which serve to move the back rest 7, which has been pivoted out into the position of use, automatically into the position of non-use when shopping trolleys 22 are pushed together. The supporting region 12 can be provided centrally with a mesh structure 13. Upwardly extending guides 15 formed by slots for slidably receiving projections on the seat 6 are provided on either side of the mesh structure 13. Openings 16 are arranged below the guides 15 and are intended to receive, e.g., a strap for strapping a child in.

It can be seen from FIG. 3 that the back rest 7 comprises three parts 17, 18, all of which are made of plastic. A first part 17 is constructed identically to the overall back rest 7, as can be seen from FIG. 2. The two other or second parts 18 are elongate and, together with the first part 17, form the arms 25 of the latter when, as indicated in the drawing by arrows, the two parts 18 are connected to the first part 17 over their common edges 26. Connection can be carried out in various known ways. Friction welding, gluing, plugging or screwing are some of these possibilities.

FIG. 4 shows a side view of a back rest 7. The first, H-shaped part 17 and one of the two other parts 18 are fixedly connected to one another. The construction of the parts 17, 18, e.g., as half-shells, is selected so that at least a portion 19 of the back rest 7 is formed as a hollow body. Reinforcing ribs 21 are arranged in this portion 19 and are arranged opposite one another within the portion 19. The outer surfaces 20 of the parts 17, 18 are smooth where it is convenient and useful because the reinforcing ribs 21 are provided on the inside. It is advantageous to provide functional elements such as bearing lugs 11, guides 15, openings 16 and the like on the first part 17 and to assign only a stabilising function to the at least one second part 18.

The person skilled in the art is entirely free in the selection of the structure and in the use of two or more parts 17, 18. For example, the back rest 7 may only comprise one first part 17 and one second part 18, which are fixedly joined together. It is also possible, e.g., for three second parts 18 to be associated with the first part 17. It is also possible to form a first and a second part 17 and 18 in such a way that an overall large portion 19, which can even comprise the entire surface area of the back rest 7, is in the form of a hollow body. Essentially, there is no limit to the possible variations. An important factor is that hollow spaces or chambers are formed at locations on the back rest 7 and that reinforcing ribs 21 or other functional elements, which are not visible from the outside but which contribute towards adequate stability and/or the function of the back rest 7, can be arranged in the hollow spaces or chambers.

Although only preferred embodiments are specifically illustrated and described herein, it will be appreciated that many modifications and variations of the present invention are possible in light of the above teachings and within the purview of the appended claims without departing from the spirit and intended scope of the invention.

1. A child seat for a shopping trolley, the child seat comprising a back rest made of plastic and adapted to be arranged on the shopping trolley so as to be pivotable about a horizontal axis and to which at least one seat is slidably or pivotably connected, the back rest comprises at least two parts fixedly connected to one another and constructed so that at least one portion of the back rest is formed as a hollow body, wherein the hollow body is defined by the at least two parts.

2. The child seat according to claim 1, wherein the back rest is formed from one first part and two second parts.

3. The child seat according to claim 1, wherein the parts are formed as half-shells.

4. The child seat according to claim 2, wherein the parts are formed as half-shells.

5. The child seat according to claim 1, further comprising internal reinforcing ribs in the at least one portion.

6. The child seat according to claim 2, further comprising internal reinforcing ribs in the at least one portion.

7. The child seat according to claim 3, further comprising internal reinforcing ribs in the at least one portion.

8. The child seat according to claim 1, wherein the first part has the same contour as the overall back rest.

9. The child seat according to claim 5, wherein the first part has the same contour as the overall back rest.

10. The child seat according to claim 8, wherein the contour is H-shaped.

11. The child seat according to claim 1, wherein functional elements are arranged on the first part.

12. The child seat according to claim 1, wherein the functional elements are bearing lugs, guides or openings.
